(19) United States
(12) Patent Application Publication
(10) Pub. No.: US 2008/0311440 A1
(43) Pub. Date: Dec. 18, 2008

(54) FUEL CELL SYSTEM AND METHOD OF OPERATING THE SAME

(75) Inventors: Young-soo Joung, Yongin-si (KR); Hye-jung Cho, Yongin-si (KR); Lei Hu, Yongin-si (KR); Jae-yong Lee, Yongin-si (KR); Young-jae Kim, Yongin-si (KR); Jin-ho Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Suwon-si (KR)

(21) Appl. No.: 12/138,895

(22) Filed: Jun. 13, 2008

(30) Foreign Application Priority Data
Jun. 15, 2007 (KR) 2007-59102

(51) Int. Cl. H01M 8/04

(52) U.S. Cl. 429/14; 429/22; 700/266

(57) ABSTRACT

A fuel cell system includes a power unit that generates power using a fuel; a fuel storage unit that stores the fuel; a fuel supply device that conveys the fuel from the fuel storage unit to the power unit; and a control unit that controls the supply of the fuel and the generation of power. The fuel supply device includes a fuel supply control device that controls the supply of fuel according to a signal generated by the control unit. The control unit includes a fuel control unit that generates the signal according to the information of the fuel storage unit and the state information of the power unit.

### CROSS-REFERENCE TO RELATED APPLICATIONS

This application claims the benefit of Korean Patent Application No. 2007-59102, filed Jun. 15, 2007, in the Korean Intellectual Property Office, the disclosure of which is incorporated herein by reference.

### BACKGROUND OF THE INVENTION

1. Field of the Invention

Example embodiments relate to a fuel cell system, and more particularly, to a fuel cell system and a method of operating the same.

2. Description of the Related Art

In order to use a fuel cell system in mobile electronic devices such as mobile phones or computer notebooks, it is desirable that the following requirements be met.

First, the consumption related to the balance of plant (BOP) for driving a fuel cell system must be small. The term “BOP” generally refers to components of a fuel cell system other than a stack and a cartridge.

A small fuel cell has a small power output. Thus, if the BOP for driving the fuel cell system increases, a total power transmitted to various devices that consume power is reduced. For this reason, it is preferable to use a BOP having low power consumption.

Second, a stable fuel supply is desirable.

In the case of a fuel cell that uses a liquid fuel, a uniform fuel supply with time is particularly desirable. A fuel supply typically includes a section that extends from a fuel storage, such as, for example, a cartridge, to a fuel supply control unit, and another section that extends from the fuel supply control section to a power unit. The uniform supply of fuel from the fuel storage to the fuel supply control unit is important for effective and accurate fuel supply control of a control device.

Third, it is desirable to supply a required amount of fuel by effectively controlling the power amount generated by a power unit. Fuel supplied to the power unit through the control device directly affects the output of the fuel cell system, and the supply of fuel is essential for stable driving of the fuel cell system. Therefore, the development of an effective fuel control system is desirable.

In the case of passive type fuel cells introduced so far, a compressive cartridge or a non-compressive cartridge is used.

FIG. 1 is a graph showing the fuel ejection characteristic of a compressive cartridge. In FIG. 1, the y-axis indicates the mass of fuel (methanol) ejected from the compressive cartridge, and the negative values show that fuel is ejected from the cartridge. The x-axis indicates time. According to the slope of graph line G of FIG. 1, as the fuel is ejected from the cartridge, the amount of fuel ejected per unit of time is reduced. This result is due to an elastic characteristic of a compressive device such as a spring included in the compressive cartridge.

More specifically, in the case of the compressive cartridge, the fuel storage, such as, for example, a pouch, may be compressed by the compressive device. However, when fuel is filled in the fuel storage, the compressive device generates a large compressive force since the compressive device may be greatly compressed by the filled fuel. However, when the fuel storage contains a small amount of fuel, the compressive force of the compressive device is reduced since the compressive device returns to its original shape. For this reason, the amount of fuel ejected from the cartridge is reduced with time. That is, the amount of fuel ejected form the cartridge is not constant with time.

If the fuel storage is a non-compressive cartridge, a pump may be used. Therefore, there may be disadvantages of large power consumption and a great amount of noise. Also, the pump may increase the manufacturing costs.

### SUMMARY OF THE INVENTION

To address the above and/or other problems, example embodiments provide a fuel cell system that has a reduced volume and noise, that can uniformly supply fuel to a fuel supply apparatus regardless of the amount of remaining fuel, and that can supply an appropriate amount of fuel to a power unit according to the state of the power unit.

Example embodiments may also provide a method of driving a fuel cell system.

According to one example embodiment, there is provided a fuel cell system comprising: a power unit that generates power using a fuel; a fuel storage unit that stores the fuel; a fuel supply device that conveys the fuel from the fuel storage unit to the power unit; and a control unit that controls the supply of the fuel and the generation of power, wherein the fuel supply device comprises a fuel supply control device that controls the supply of fuel according to a signal generated by the control unit, and the control unit comprises a fuel control unit that generates the signal according to the information of the fuel storage unit and the state information of the power unit.

According to a non-limiting aspect, the control unit may further comprise a memory unit that comprises at least first reference data that comprises a first driving condition to drive the fuel supply control device according to the state information of the power unit and second reference data that comprises a second driving condition to drive the fuel supply control device according to the amount of fuel remaining in the fuel storage unit.

According to a non-limiting aspect, the fuel storage unit may comprise a measuring apparatus that measures information of the fuel storage unit and an interface that transmits information of the fuel storage unit measured by the measuring apparatus to the fuel control unit.

According to a non-limiting aspect, the power unit may comprise a membrane electrode assembly (MEA) that generates power using the fuel and a measuring apparatus that transmits the state information of the power unit to the fuel control unit.

According to a non-limiting aspect, the fuel cell system may further comprise an auxiliary battery, a DC-DC converter, and a charger.

According to a non-limiting aspect, the fuel supply control device may be a valve or a pump.

According to a non-limiting aspect, the information of the fuel storage unit may be one of data that indicates the amount of fuel remaining and the fuel concentration, the volume of the fuel storage unit, and other recognition information of the fuel storage unit. The state information of the power unit may be a temperature, an output voltage, or an output current of the power unit.

According to another example embodiment, there is provided a method of driving the fuel cell system, the method comprising recognizing information of the fuel storage unit; setting a driving condition of the fuel supply control device by comparing the recognized information with reference data stored in the control unit; and not-supplying or supplying fuel by driving the fuel supply control device according to the set driving condition.

According to another example embodiment, there is provided a method of driving the fuel cell system, the method comprising: recognizing state information of the power unit; setting a first driving condition of the fuel supply control device by comparing the recognized state information with first reference data stored in the control unit; recognizing information of the fuel storage unit; setting a second driving condition of the fuel supply control device by comparing the recognized information of the fuel storage unit with second reference data stored in the control unit; and not-supplying or supplying fuel by driving the fuel supply control device according to the first driving condition and the second driving condition.

According to a non-limiting aspect, the first driving condition and the second driving condition may be applied at the same period or sequentially applied with time.

According to a non-limiting aspect, the first driving condition may be a first driving period of the fuel supply control device, and the second driving condition may be a second driving period of the fuel supply control device.

According to a non-limiting aspect, the second driving condition may be applied at least two times to the fuel supply control device when the fuel supply control device is driven for one period according to the first driving condition.

According to a non-limiting aspect, the first driving condition may be applied at least two times to the fuel supply control device when the fuel supply control device is driven for one period according to the first driving condition.

According to a non-limiting aspect, the first driving condition and the second driving condition may be applied to a driver that controls the driving of the fuel supply control device.

According to a non-limiting aspect, when the first driving condition is a first driving period and the second driving condition is a second driving period, the first driving period may be equal to or greater than the second driving period.

According to a non-limiting aspect, the second reference data may be driving data to drive the fuel supply control device so that fuel is uniformly supplied per unit time in accordance with the information change of the fuel storage unit.

According to a non-limiting aspect, the information of the fuel storage unit may be one of data that indicates the remaining fuel, fuel concentration, volume of the fuel storage unit, and other recognition information of the fuel storage unit, and the state information of the power unit may be a temperature, an output voltage, or an output current of the power unit.

According to a non-limiting aspect, the first reference data may be driving data to drive the fuel supply control device so that fuel is supplied to the power unit in accordance with the state change of the power unit.

The use of the fuel cell systems according to the example embodiments may simplify the configuration of the fuel cell system, and thus, may reduce manufacturing costs and power loss according to the driving of a pump. In the fuel cell systems according to the example embodiments, since it is possible to reduce capacity of a pump or a valve used to deliver fuel to a power unit, the volume of the fuel supply device and noise of the pump may be reduced. Also, the fuel cell system may be economical because a pump having a large capacity may be replaced with a compressive cartridge and a pump having a small capacity. Also, fuel may be uniformly supplied to the fuel supply device, and an appropriate amount of fuel may be supplied to a power unit according to the operation state of the power unit.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a graph showing the fuel ejection characteristic of a conventional compressive cartridge;

FIG. 2 is a block diagram illustrating a fuel cell system according to at least one example embodiment;

FIG. 3 is a graph showing the fuel ejection characteristics of a cartridge obtained by an experiment in which a fuel supply control device is driven according to reference data in which driving conditions of the fuel supply control device according to the amount of fuel remaining in a cartridge are set;

FIG. 4 is a graph showing outputs, temperature and fuel supply characteristics of a fuel cell system obtained by an experiment in which a fuel supply control device is driven according to reference data in which driving conditions of the fuel supply control device according to remaining fuel in a cartridge and reference data in which driving conditions of the fuel supply control device according to a state of a power unit are set; and

FIG. 5 is a block diagram illustrating a method of driving of the fuel cell system of FIG. 2.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. Specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved. In the drawings, the thicknesses of layers and regions may be exaggerated for clarity.

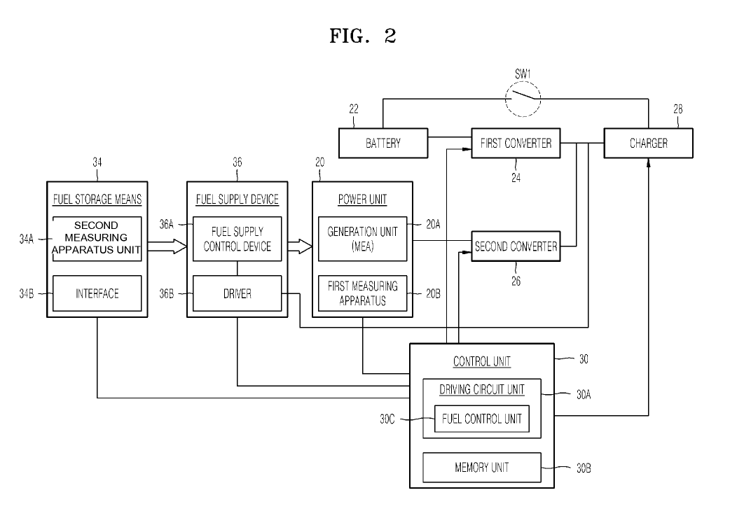

FIG. 2 is a block diagram illustrating a fuel cell system according to at least one example embodiment. Referring to FIG. 2, the fuel cell system includes a power unit 20, an auxiliary battery 22, a first converter 24, a second converter 26, a charger 28, a control unit 30, a fuel supply device 36, and a fuel storage unit 34. A switch SW is included between the charger 28 and the auxiliary battery 22. The power unit 20 includes a generation unit 20A which receives fuel from the fuel storage unit 34 through the fuel supply device 36 to generate power. The second converter 26 connected to the power unit 20 may be a DC-DC converter. The second converter 26 stabilizes power outputted from the power unit 20, and transforms the power to be suitable for a load. The auxiliary battery 22 connected parallel to the power unit 20 is used to supply power to a load together with the power unit 20. A voltage outputted from the auxiliary battery 22 may be smaller than a voltage outputted from the power unit 20. The first converter 24 connected to the auxiliary battery 22 transforms power outputted from the auxiliary battery 22 to be suitable for a load. The first converter 24 and the second converter 26 are connected in parallel to each other and are activated by an enable signal given by the control unit 30. The charger 28 may commonly be connected to the first converter 24 and the second converter 26. Also, the charger 28 transforms power inputted through the first and second converters 24 and 26 to be suitable for a power level to a load. Also, in the process of consuming the remaining fuel, the charger 28 may be used for charging the auxiliary battery 22 using power generated by consuming the remaining fuel. The charger 28 may be activated by an enable signal generated by the control unit 30.

The generation unit 20A may include a membrane electrode assembly (MEA), and may be of a monopolar or a stack type. The power unit 20 includes a first measuring apparatus 20B that measures state information of the power unit 20 and sends the state information to the control unit 30. The state information may be temperature, current, and voltage of the power unit 20. For example, the state information may be a temperature, an output voltage, and an output current of the MEA which substantially generates power. The fuel storage unit 34 may be a cartridge, such as, for example, a compressive cartridge or a non-compressive cartridge. The fuel storage unit 34 includes a second measuring apparatus 34A and an interface 34B. The second measuring apparatus 34A may measure the state information of the fuel storage unit 34, and send the state information to the control unit 30. The state information of the fuel storage unit 34 may be transmitted to the control unit 30 through the interface 34B. The state information of the fuel storage unit 34 measured by the second measuring apparatus 34A may be recognition information of the fuel storage unit 34. For example, if the fuel storage unit 34 is a compressive cartridge, the state information may be the volume of a fuel pack which is included in the cartridge and stores fuel, the amount of fuel remaining in the fuel pack, the concentration of the fuel, and information related to the manufacture of the cartridge. The amount of remaining fuel may be indicated by electric information, such as, for example, an electrical resistance of the cartridge that varies according to the remaining fuel.

The fuel supply device 36 is included between the fuel storage unit 34 and the power unit 20. The fuel supply device 36 supplies fuel supplied from the fuel storage unit 34 to the power unit 20 according to conditions. The fuel supply device 36 includes a fuel supply control device 36A and a driver 36B. The fuel supply device 36 may further include other components for smoothly and correctly supplying fuel other than the fuel supply control device 36A and the driver 36B. The driver 36B controls the operation of the fuel supply control device 36A according to an operation signal generated from the control unit 30, in particular, a fuel control unit 30A. Power required for driving the driver 36B may be supplied from the first converter 24. If the fuel storage unit 34 is a compressive cartridge, the fuel supply control device 36A may be a valve or a pump having a small capacity. On the other hand, if the fuel storage unit 34 is a non-compressive cartridge, the fuel supply control device 36A may be a pump having a sufficient capacity to pump fuel from the fuel storage unit 34. The driver 36B may control the operation of the fuel supply control device 36A according to an ON and OFF pulse signal received from the control unit 30. If the fuel supply control device 36A is a pump, the control unit 30 may directly send an operation control signal to the fuel supply control device 36A.

The control unit 30 may control the entire fuel cell system. The control unit 30 includes a driving circuit unit 30A and a memory unit 30B. The control unit 30 may be, for example, a central processing unit. The driving circuit unit 30A includes a fuel control unit 30C. The fuel control unit 30C may analyze first information generated by the first measuring apparatus 20B of the power unit 20 and second information generated by the second measuring apparatus 34A of the fuel storage unit 34 through the interface 34B. The fuel control unit 30C sets a driving condition of the fuel supply control device 36A by comparing the analyzed result with reference data stored in the memory unit 30B. Also, the fuel control unit 30C sends an operation signal to the fuel supply device 36 so that the fuel supply control device 36A is operated according to the set driving condition. The driver 36B of the fuel supply device 36 may supply fuel or stop supplying fuel by turning ON or OFF the fuel supply control device 36A according to an enable signal, that is, an operation signal given by the fuel control unit 30C.

The memory unit 30B may include first reference data that is compared with the first information and second reference data that is compared with the second information.

The second reference data includes driving conditions required for driving the fuel supply control device 36A so that a constant amount of fuel is supplied to the generation unit 20A from the fuel storage unit 34 regardless of the amount of the remaining fuel in the fuel storage unit 34. Since the fuel supply control device 36A may be driven according to the driving condition, fuel may be uniformly supplied to the generation unit 20A during an entire period of using the fuel stored in the fuel storage unit 34.

For example, when information based on the amount of fuel remaining in the fuel storage unit 34 is transmitted to the fuel control unit 30C from the second measuring apparatus 34A, the fuel control unit 30C may determine the amount of fuel remaining in the fuel storage unit 34 by analyzing the information transmitted from the second measuring apparatus 34A. If the fuel control unit 30C determines that the remaining fuel in the fuel storage unit 34 is 60%, the fuel control unit 30C may search the memory unit 34B for second reference data relating to an ON time and OFF time of the fuel supply control device 36A when the remaining fuel in the fuel storage unit 34 is 60% and use the found second reference data to control the fuel supply control device 36A. If the fuel supply control device 36A is driven according to the driving condition used as described above, the amount of fuel supplied from the fuel storage unit 34 to the fuel supply device 36 may be maintained fairly constant within a tolerable range regardless of the amount of fuel remaining in the fuel storage unit 34.

The second reference data may be prepared in the following manner. For purposes of this explanation, the fuel storage unit 34 may be a compressive cartridge, and the fuel supply control device 36A may be a valve. More specifically, the compressive cartridge may include a variable resistor to obtain information with regard to the amount of fuel remaining. Variations in the amount of fuel remaining in the compressive cartridge may be determined from the resistance changes of the variable resistor, which may thus indicate variations of the amount of fuel ejected from the compressive cartridge. Such variations are correlated with the driving of a valve to measure how the amount of fuel remaining in the compressive cartridge varies according to the driving condition of the valve. From the measured data, correlation data between the amount of fuel remaining in the compressive cartridge and the driving condition of the valve such that the variation of the remaining fuel according to time can be kept constant is identified. The correlation data may be a valve driving condition that keeps the variation of the remaining fuel constant with respect to time t or may be correlation data that maintain the amount of fuel ejected from the compressive cartridge constant. The term “valve driving condition” refers to an operation period (ON time+OFF time) of the valve.

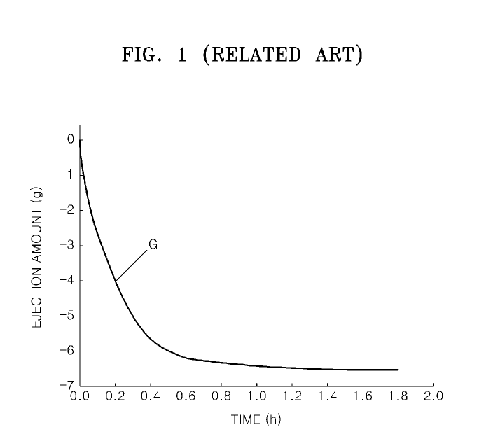

A fuel ejection experiment using the second reference data will now be described. In the experiment, a valve was used as the fuel supply control device 36A. Also, the compressive cartridge having the variation characteristic with respect to remaining fuel (a fuel ejection characteristic) as depicted in FIG. 1 was used.

Table 1 summarizes the second reference data with respect to a compressive cartridge having the variation characteristic of the remaining fuel as depicted in FIG. 1.

TABLE 1

| Remaining | Corresponding | Valve operation | Valve operation |
|---|---|---|---|
| Fuel (%) | voltage (V) | period (sec) | time (sec) |
| 100 | 0.107 | 12 | 0.1 |
| 80 | 0.489 | 9 | |
| 60 | 0.529 | 6 | |
| 40 | 0.709 | 4 | |
| 20 | 0.921 | 2 | |

In Table 1, the term “remaining fuel” refers to the amount of fuel remaining in the compressive cartridge, and the term “corresponding voltage” refers to a voltage corresponding to the resistance that indicates the amount of fuel in the compressive cartridge. Also, the term “valve operation time” refers to the “ON time” of the valve in the given segment of time, referred to as the “valve operation period”.

Referring to Table 1, the valve operation time may remain constant at 0.1 second regardless of the amount of fuel remaining. However, the valve operation period may be reduced as the amount of the remaining fuel is reduced. Thus, as the amount of remaining fuel reduces, the OFF time of the valve may be reduced. Also, as the amount of fuel remaining in the compressive cartridge is reduced, the corresponding voltage may be increased.

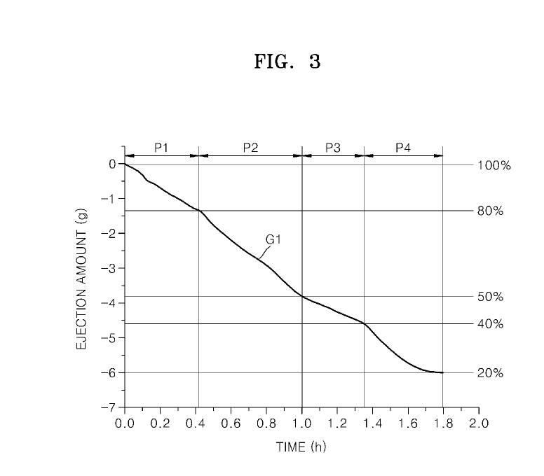

FIG. 3 is a graph showing the percentage of fuel remaining in the fuel storage unit 34 (shown on the right scale as a percentage) according to time, as plotted by the line G1. The left scale shows the mass of fuel ejected from the fuel storage unit 34 to the fuel supply device 36 according to time, which correlates inversely with the amount of fuel remaining in the fuel storage unit 34. Variations in the amount of fuel ejected and the amount of fuel remaining per unit of time can be determined from changes to the slope of the line G1. A compressive cartridge having the fuel remaining characteristic of FIG. 1 was used as the fuel storage unit 34 and the driving of the fuel supply control device 36A was controlled using the data of Table 1 as the second reference data.

In FIG. 3, in a first period P1, the remaining fuel is reduced from 100% to 80% and the line G1 has a first slope. In a second period P2, the remaining fuel is reduced from 80% to 50% and the line G1 has a second slope. In a third period P3, the remaining fuel is reduced from 50% to 40% and the line G1 has a third slope. In a fourth period P4, the remaining fuel is reduced from 40% to 20% and the line G1 has a fourth slope.

Referring to FIG. 3, in each of the periods, the slopes may remain constant. However, the slopes among the periods may be slightly different. However, an overall slope of the remaining fuel line G1 is nearly a straight line. Thus, it is seen that the slopes among the periods are not significantly different. That is, the difference of the slopes among the periods is negligible.

Thus, if the fuel supply control device 36A is controlled using the second reference data, the amount of fuel supplied per unit time to the fuel supply device 36 from the fuel storage unit 34 may be uniformly maintained. Therefore, fuel may be stably supplied to the fuel supply device 36 regardless of the amount of fuel remaining in the fuel storage 34. Also, fuel may be uniformly supplied to the fuel supply device 36 during an entire period of using the fuel in the fuel storage unit 34 regardless of the amount of fuel remaining in the fuel storage unit 34.

The first reference data may include data with respect to a driving condition of the fuel supply control device 36A to supply an appropriate amount of fuel to the power unit 20 according to the operation state of the power unit 20. For example, the first reference data may include a driving period (ON time+OFF time) of the fuel supply control device 36A so that an appropriate amount of fuel may be supplied to the power unit 20 according to a temperature, an output current, or an output voltage of the generation unit 20A of the power unit 20. A first driving period of the fuel supply control device 36A according to the first reference data may include the second driving period of the fuel supply control device 36A determined according to the second reference data. In the first driving period, the OFF time can be set to infinity. Thus, the fuel supply to the fuel supply device 36 from the fuel storage unit 34 may be blocked. Also, during the ON time of the first driving period, the fuel supply control device 36A may be controlled according to the second driving period.

The output state of the power unit 20 may vary according to an operation state of a load. Thus, the amount of fuel supplied during an ‘ON time’ of the first driving period may be equal to the amount of fuel supplied by one or more frequencies according to the second driving period during the first driving period. Accordingly, an average amount of fuel supply per unit time during the first driving period, that is, the slope of amount of fuel supply, may be greater or smaller than the slope of the remaining fuel variation graph G1 of FIG. 3.

As a result, the driving condition (a second driving condition) of the fuel supply control device 36A according to the second reference data may be used to equally divide the first driving period into shorter driving periods.

For example, if the second driving period, in the driving condition (a second driving condition) of the fuel supply control device 36A according to the second reference data, is 10 seconds, the first driving period of the fuel supply control device 36A may be set up to be, for example, 400 seconds (supplying time 100 seconds+not-supplying time 300 seconds) or 650 seconds (supplying time 50 seconds+not-supplying time 600 seconds) according to the temperature, output current, or output voltage of the fuel cell system. The supplying time (100 seconds or 50 seconds) of the first driving period may be divided into 10 second periods, corresponding to the second driving period.

If the temperature, output current, or output voltage of the fuel cell system changes frequently according to loads, in the first driving condition, the fuel supply control device 36A may be stopped for three times by setting up the second driving period as 2 sec, 3 sec, and 5 sec during the second driving period, for example, 10 seconds. At this point, the ON time of the fuel supply control device 36A between the stops may be equal (for example, 0.1 second) or different.

If the load is in a static state such as a waiting state, and the state change of the power unit 20 is slow, for example, the change of temperature of the generation unit 20A is slow, the first driving period may be identical to the second driving period.

If the period of state change, such as, for example, the change of temperature of the power unit 20, is greater than the second driving period, in other words, the first driving period is greater than the second driving period, the supplying time of the first driving period may include the second driving period. Thus, the supplying time of the first driving period may be divided into the second driving periods, thereby controlling the fuel supply.

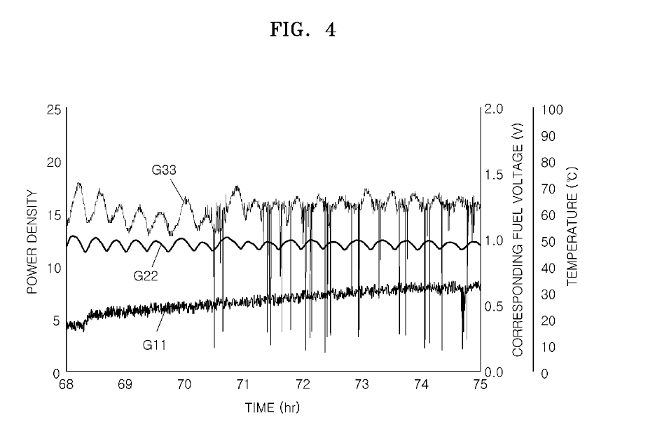

FIG. 4 is a graph showing the power output, temperature, and fuel supply characteristics of a fuel cell system in an experiment of driving the fuel cell system by applying the second driving condition and the first driving condition.

In the above experiment, the first driving condition was applied based on the temperature of the fuel cell system, specifically, the temperature of the generation unit 20A, using 50° C. as a reference.

In the experiment to obtain the result shown in FIG. 4, when the temperature of the fuel cell system was 50° C. or above, the fuel supply control device 36A was controlled by the first driving condition to be in the non-supplying state, and when the temperature of the fuel cell system was less than 50° C., the fuel supply control device 36A was controlled to be by the first driving condition in the supplying state. Also, the data of Table 1 were used as the second driving condition.

In FIG. 4, a first graph line G11 indicates the amount of fuel supplied, a second graph line G22 indicates the temperature of the fuel system, and a third graph line G33 indicates the power density of the fuel cell system. The amount of fuel supplied is expressed as output voltage of the fuel storage unit 34. As it is seen from Table 1, as the output voltage increases, the amount of fuel remaining in the fuel storage unit 34 is reduced. A smaller amount of fuel remaining indicates that the amount of fuel supplied is large. In other words, the output voltage may be proportional to the amount of fuel supplied. Therefore, the first graph G11 expressed as an output voltage indicates the amount of fuel supplied.

Referring to the first graph G11 of FIG. 4, it is seen that the amount of fuel supplied per unit time was constant. From this fact, it may be said that fuel from the fuel storage unit 34 was uniformly supplied to the fuel supply device 36 during the entire supply period.

Referring to the second graph G22 of FIG. 4, the system temperature was also stably controlled to be around 50° C.

Referring to the third graph G33 of FIG. 4, overall power density of the fuel cell system was also stably controlled.

From the results of FIG. 4, it is seen that, when the fuel supply control device 36A is controlled using the first and second driving conditions, the fuel supply characteristic, temperature characteristic, and power output characteristic of the fuel cell system may be stably controlled.

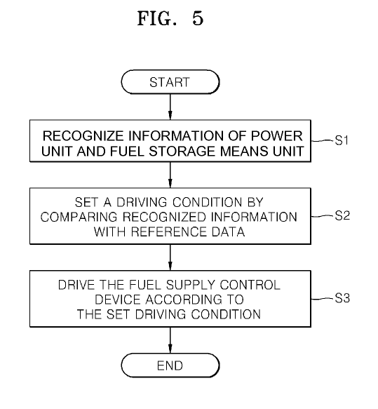

A method of supplying fuel using the fuel cell system described above will now be described. Referring to FIG. 5, first information of the power unit 20 and second information of the fuel storage unit 34 may be recognized (S1). More specifically, second information such as a fuel remaining signal (for example, a voltage signal), the volume of the fuel storage unit 34, the concentration of the fuel may be transmitted from the second measuring apparatus 34A in the fuel storage unit 34 to the fuel control unit 30C of the control unit 30 through the interface 34B. The first information such as the temperature, power output voltage, and/or power current of the power unit 20 may be transmitted to the fuel control unit 30C. The transmitted first information and second information, such as, for example, the temperature of the power unit 20 and the remaining fuel in the fuel storage unit 34, respectively, may be recognized by the fuel control unit 30C. The first information and second information may be recognized simultaneously or not simultaneously. For example, after the second information is recognized, the first information may be recognized.

Next, a driving condition may be set by comparing the recognized first information and second information with reference data stored in the memory unit 30B (S2).

More specifically, the first driving condition may be set by comparing the recognized first information with first reference data stored in the memory unit 30B. The second driving condition may be set by comparing the recognized second information with second reference data stored in the memory unit 30B.

The first driving condition may be the first driving period, and the second driving condition may be the second driving period. Generally, the second driving period will be shorter than the first driving period. However, in a particular case, such as, for example, when a load changes rapidly or temperature around the power unit 20 changes rapidly, the first driving period may be equal to or shorter than the second driving period. Also, two or more second driving periods having different periods from each other may be present in the first driving period. For example, a second driving period having a period of 4 seconds and another second driving period having a period of 6 seconds may be present in the first driving period.

The fuel supply control device 36A may be driven according to the set driving condition (S3). More specifically, an enable signal may be applied to the driver 36B of the fuel supply device 36 (or directly to the fuel supply control device 36A) from the control unit 30 so that the fuel supply control device 36A may be driven according to the set first and second driving conditions.

As the fuel supply control device 36A is driven according to the second driving period, a uniform amount of fuel per unit time is supplied to the fuel supply device 36 from the fuel storage unit 34. At this point, the fuel supplied to the fuel supply device 36 may be supplied to the power unit 20 by dividing into an appropriate amount of fuel required to the power unit 20 by the fuel supply control device 36A which is driven (stop supplying or supplying fuel) according to the second driving condition during the first driving period.

While the example embodiments have been shown and described with reference to embodiments thereof, it should not be construed as being limited to such embodiments. Those skilled in this art know, for example, the structural and methodological at least one example embodiment may be applied to a fuel cell system that does not include a battery. Also, after the first information and second information are recognized, the driving of the fuel supply control device 36A may be simultaneously performed according to the first and second reference data. Also, after the driving of the fuel supply control device 36A begins according to the second reference data, a driving condition according to the first reference data may be applied to the fuel supply control device 36A. Therefore, the scope of the invention is not defined by the detailed description of the invention but by the appended claims.

As described above, in the example embodiments, a fuel pump and a driving circuit may be omitted by using a compressive cartridge. Thus, the fuel cell system according to example embodiments may have a simple structure, the costs of parts may be reduced, and power loss due to the pump driving may be reduced.

Also, since the example embodiments use a compressive cartridge, the noise and the volume of a fuel supply device may be reduced by reducing the capacity of the pump or using a valve instead of the pump.

Also, when a pump having a small capacity is used together with the compressive cartridge, a pump having a large capacity may be unnecessary, and thus, the fuel cell system according to the example embodiments is economical.

Also, fuel may be uniformly supplied to a fuel supply device by driving a fuel supply control device (a valve or a pump) according to a driving condition of the second reference data that corresponds to remaining fuel in a compressive cartridge. According to an operation state of a power unit, an appropriate amount of fuel may be supplied to the power unit by controlling the fuel supply control device according to the driving condition of the first reference data that corresponds to state information, for example, the temperature of the power unit.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A fuel cell system comprising:
a power unit that generates power using a fuel;
a fuel storage unit that stores the fuel;
a fuel supply device that conveys the fuel from the fuel storage unit to the power unit; and
a control unit that controls the supply of the fuel and the generation of power,
wherein the fuel supply device comprises a fuel supply control device that controls the supply of fuel according to a signal generated by the control unit, and
the control unit comprises a fuel control unit that generates the signal according to information of the fuel storage unit and state information of the power unit.

2. The fuel cell system of claim 1, wherein the control unit further comprises a memory unit, wherein the memory unit comprises at least:
first reference data that comprises a first driving condition to drive the fuel supply control device according to the state information of the power unit; and
second reference data that comprises a second driving condition to drive the fuel supply control device according to the amount of fuel remaining in the fuel storage unit.

3. The fuel cell system of claim 1, wherein the fuel storage unit comprises:
a measuring apparatus that measures information of the fuel storage unit; and
an interface that transmits information of the fuel storage unit measured by the measuring apparatus to the fuel control unit.

4. The fuel cell system of claim 1, wherein the power unit comprises:
a membrane electrode assembly (MEA) that generates power using the fuel; and
a measuring apparatus that transmits the state information of the power unit to the fuel control unit.

5. The fuel cell system of claim 1, further comprising an auxiliary battery, a DC-DC converter, and a charger.

6. The fuel cell system of claim 1, wherein the fuel supply control device is a valve or a pump.

7. The fuel cell system of claim 1, wherein the information of the fuel storage unit is one of data that indicates the amount of fuel remaining in the fuel storage unit, the fuel concentration, the volume of the fuel storage unit, and other recognition information of the fuel storage unit.

8. The fuel cell system of claim 1, wherein the state information of the power unit is a temperature, an output voltage, or an output current of the power unit.

9. A method of driving a fuel cell system, the method comprising:
recognizing information of a fuel storage unit;
setting a driving condition of a fuel supply control device by comparing the recognized information with reference data stored in a control unit; and
not-supplying or supplying fuel to a power unit by driving the fuel supply control device according to the set driving condition.

10. A method of driving a fuel cell system, the method comprising:
recognizing state information of a power unit;
setting a first driving condition of a fuel supply control device by comparing the recognized state information with first reference data stored in a control unit;
recognizing information of a fuel storage unit;
setting a second driving condition of the fuel supply control device by comparing the recognized information of the fuel storage unit with second reference data stored in the control unit; and
not-supplying or supplying fuel to the power unit by driving the fuel supply control device according to the first driving condition and the second driving condition.

11. The method of claim 10, wherein the first driving condition and the second driving condition are applied at the same period or are sequentially applied with time.

12. The method of claim 9, wherein the driving condition is a driving period of the fuel supply control device.

13. The method of claim 10, wherein the first driving condition is a driving period of the fuel supply control device.

14. The method of claim 10, wherein the second driving condition is applied at least two times to the fuel supply control device when the fuel supply control device is driven for one period according to the first driving condition.

15. The method of claim 14, wherein the first driving condition and the second driving condition are applied to a driver that controls the driving of the fuel supply control device.

16. The method of claim 10, wherein, when the first driving condition is a first driving period and the second driving condition is second driving period, the first driving period is equal to or greater than the second driving period.

17. The method of claim 9, wherein the reference data is driving data to drive the fuel supply control device so that fuel is uniformly supplied per unit time in accordance with the information change of the fuel storage unit.

18. The method of claim 9, wherein the information of the fuel storage unit is one of data indicating the remaining fuel, fuel concentration, volume of the fuel storage unit, and other recognition information of the fuel storage unit.

19. The method of claim 10, wherein the first reference data is driving data to drive the fuel supply control device so that fuel is supplied to the power unit in accordance with a state change of the power unit.

20. The method of claim 10, wherein the state information of the power unit is a temperature, an output voltage, or an output current of the power unit.

21. The method of claim 9, wherein the control unit comprises a memory unit that comprises reference data.

22. The method of claim 10, wherein the control unit comprises a memory unit that comprises first reference data and the second reference data.

23. The method of claim 9, wherein the fuel storage unit comprises:
a measuring apparatus that measures information of the fuel storage unit; and
an interface that transmits the information of the fuel storage unit measured by the measuring apparatus to the fuel control unit.

24. The method of claim 9, wherein the power unit comprises:
an MEA that generates power using the fuel; and
a measuring apparatus that transmits the state information of the power unit to the fuel control unit.

25. The method of claim 9, further comprising an auxiliary battery, a DC-DC converter, and a charger.

26. The method of claim 10, wherein the fuel storage unit comprises:
a measuring apparatus that measures information of the fuel storage unit; and
an interface that transmits the information of the fuel storage unit measured by the measuring apparatus to the fuel control unit.

27. The method of claim 10, wherein the power unit comprises:
an MEA that generates power using the fuel; and
a measuring apparatus that transmits the state information of the power unit to the fuel control unit.

28. The method of claim 10, further comprising an auxiliary battery, a DC-DC converter, and a charger.

29. The method of claim 10, wherein the fuel supply control device is a valve or a pump.

30. The method of claim 14, wherein the at least two times that the second driving condition is applied are at least two different fuel remaining periods of the fuel storage unit.
